(19) United States
(12) Patent Application Publication
(10) Pub. No.: US 2014/0279513 A1
(43) Pub. Date: Sep. 18, 2014

(54) RESERVE CARD SYSTEM AND METHOD

(71) Applicant: American Express Travel Related Services Company, Inc., (US)

(72) Inventors: Sarah Dodds-Brown, New Rochelle, NY (US); Manish Gupta, Haworth, NJ (US); Frank Holbrook, Williston Park, NY (US); David Lago, Woodhaven, NY (US); Nina Owens, East Setauket, NY (US); Kishore Ponnavalu, New York, NY (US)

(73) Assignee: American Express Travel Related Services Company Inc., New York, NY (US)

(21) Appl. No.: 13/830,146

(22) Filed: Mar. 14, 2013

Related U.S. Application Data
(63) Continuation of application No. 13/830,049, filed on Mar. 14, 2013.

(51) Int. Cl. G06Q 20/40

(52) U.S. Cl. CPC G06Q 20/4016
USPC 705/44

(57) ABSTRACT

A system, method and/or computer program product for enrolling in and/or issuing a transaction account with enhanced capabilities and improved functionality is disclosed herein. This new type of transaction account, a reserve transaction account, is disclosed herein. Similar to credit and/or charge transaction accounts, the reserve transaction account avails its users the ability to purchase now and pay for the purchase at a later date. This is in contrast to a debit transaction account where payment for the purchase is effective almost immediately. Similar to credit and/or charge transaction accounts, the reserve transaction account is associated with a line of credit. Similar to credit and/or charge transaction accounts for authorization and settlement, the reserve transaction account follows a dual messaging protocol for authorization of transactions.

### CROSS REFERENCE TO RELATED APPLICATION

This application is a continuation of, and claims priority to and the benefit of, U.S. Ser. No. 13/830,049 filed on Mar. 14, 2013 and entitled “RESERVE CARD SYSTEM AND METHOD,” which is incorporated herein by reference.

### BACKGROUND

1. Field

The present disclosure generally relates to transaction accounts and transaction tools.

2. Related Art

A credit card is a payment instrument issued to users as a system of payment. A credit card allows the cardholder to pay for goods and services based on the holder's promise to pay. The issuer of the card creates a revolving account and grants a line of credit to the consumer (or the user) from which the user can borrow money for payment to a merchant or as a cash advance to the user. A debt is created when a creditor agrees to lend a sum of assets to a debtor. Debt is usually granted with expected repayment. In most cases of modern society, this includes repayment of the original sum, plus interest.

A credit card is different from a charge card. A charge card generally requires the balance to be paid in full each month. In contrast, credit cards allow the consumers a continuing balance of debt, subject to interest being charged. A credit card also generally differs from a cash card, which can be used like currency by the owner of the card. An ATM card (also known as a bank card, client card, key card, or cash card) is a card issued by a financial institution, such as a bank, credit union, or building society, that can be used in an automated teller machine (ATM) for transactions such as: deposits, withdrawals, obtaining account information, and other types of transactions, often through interbank networks.

A debit card (also known as a bank card or check card) is generally a plastic card that provides the cardholder electronic access to his or her bank account(s) at a financial institution. Some cards have a stored value with which a payment is made, while most relay a message to the cardholder's bank to withdraw funds from a payee's designated bank account. The card, where accepted, can be used instead of cash when making purchases. In general, as the usage of the debit card is limited to available funds, it is unlikely a user can spend more than the funds they have on hand using a debit card.

What is needed is a transaction instrument that provides potential benefits to users, while assisting in the user's ability to pay without incurring unwanted debts.

### SUMMARY

The present disclosure meets the various needs described above by providing a system, method and computer program product for a transaction account that delivers benefits to users, while assisting in the user's ability to plan for and pay without incurring unwanted debt. Financial institutions are currently taking steps to ensure that the fees that merchants and other entities are charged for accepting transaction instruments are reasonable and proportional to the costs incurred, and to limit restrictions placed on small businesses and other entities that accept these transaction instruments. The system and products described herein does not run afoul of this desire.

An exemplary method and system disclosed herein includes receiving (by a third party computer based system for authorizing purchases) an authorization request for a transaction from a merchant involving a transaction account (e.g., reserve transaction account). As used herein, a “reserve transaction account” may include a transaction account that may or may not include a physical card (e.g., a Reserve Card). The method further comprises determining if the transaction should be authorized based on a comparison of transaction details to an individualized risk model tailored to a transaction account holder. The authorization decision is then transmitted to an issuer of the transaction account. The method further comprises receiving an instruction to processes the transaction from the issuer and transmitting the decision to process the transaction to the merchant. The method further comprises transmitting transaction settlement information to the issuer. In response to receipt of the transaction settlement information, a value of funds associated with (e.g., equal to) the value of funds for the transaction, is transferred from a demand deposit account associated with the transaction account to a shadow demand deposit account, wherein both the demand deposit account and the shadow demand deposit account are held by the transaction account holder. Each of the demand deposit account and the shadow demand deposit account are available to the transaction account holder on demand for any reason.

According to various embodiments, the individualized fraud risk model may be updated based on the decision to process each transaction. The transmitted authorization decision is appended to an ISO formatted point of sale device protocol message. Additionally, details indicating a reason for the transmitted authorization decision may be appended to an ISO formatted point of sale device protocol message.

A transaction account holder may elect automatic payment of the transaction account from the shadow demand deposit account. Due to the reserve transaction account being similar to a credit or charge transaction account's lack of guarantee of repayment, the issuer undertakes risk of default on payment of a balance of the transaction account. The reserve transaction account comprises a dual messaging protocol for authorization and settlement.

The reserve transaction account is tied to a line of credit. The method may further include dynamically adjusting the line of credit based on each decision to process the transaction. This adjusting may occur substantially in concert with the receipt of the instruction to process the transaction. This dynamically adjusted line of credit and a calculated remaining credit limit may be transmitted to the transaction account holder in substantially real-time.

According to various embodiments, an incentive may be awarded to the transaction account holder for electing automatic payment of the transaction account from the shadow demand deposit account. The shadow demand deposit account may be established in response to the transaction account holder being approved for the transaction account. The instruction to processes the transaction from the issuer may be associated with transmitted authorization decisions not to process the transaction. For instance, a third party responsible for authorizing purchases may make a determination that the transaction should not be processed. The issuer may ignore this instruction and determine to process the transaction despite the third party determination.

The reserve transaction account is not a debit account. The demand deposit account is at least one of a savings account, a checking account, asset managed investment, accounts and retirement account. Demand deposit account ownership may be used as the criteria for being issued the transaction account. The credit limit of the reserve transaction account may be tied to the sum of the balance of the demand deposit account and the balance of the shadow demand deposit account.

### BRIEF DESCRIPTION OF THE DRAWINGS

The features and advantages of the present disclosure will become more apparent from the detailed description set forth below when taken in conjunction with the drawings. The left-most digit of a reference number identifies the drawing in which the reference number first appears.

FIGS. 1A and 1B show exemplary depictions of movement of funds in response to cardholder actions, in accordance with various embodiments;

FIG. 2 shows a flowchart depicting an exemplary transaction process and settlement flow having third party fraud assessment decisioning, in accordance with various embodiments;

FIG. 3 shows a flowchart depicting an exemplary transaction process and settlement flow having third party authorization decisioning, in accordance with various embodiments;

FIG. 4 shows a flowchart depicting an exemplary transaction process and settlement flow, in accordance with various embodiments; and

FIG. 5 shows a flowchart depicting an exemplary backend settlement process, in accordance with various embodiments.

### DETAILED DESCRIPTION

According to various exemplary embodiments, a system, method and/or computer program product for enrolling in and/or issuing a transaction account with enhanced capabilities and improved functionality is disclosed. As mentioned previously, historically various products have been developed to assist with consummating transactions and alleviate the need to carry cash. These may comprise charge, credit and debit transaction accounts and/or instruments. Each of these accounts has various benefits and potential harms. Though they are generally accepted via similar point of sale devices, as noted previously, these products are different.

According to various exemplary embodiments, a new type of transaction account/instrument (e.g., a Reserve Card or reserve transaction account) is disclosed herein. Similar to credit and/or charge transaction accounts, the reserve transaction account avails its users the ability to purchase now and pay for the purchase at a later date. This is in contrast to a debit transaction account where payment for the purchase is effective almost immediately. Stated another way, using a debit transaction account, funds are transferred from a demand deposit account 150 linked to the debit transaction account and transmitted to another account held by another user, such as a merchant account. A demand deposit account is generally an account where funds deposited and held for later use. A demand deposit account is usually associated with one or more of checking account, savings account, asset managed investment account and/or a retirement account.

According to various exemplary embodiments, similar to credit and/or charge transaction accounts, the reserve transaction account is tied to a line of credit. This is in contrast to a debit transaction account where, in general, the transaction limit is determined by the balance of a bank account tied to the debit transaction account. The reserve transaction account may allow for overdraft protection if desired as further discussed below.

According to various exemplary embodiments, similar to credit and/or charge transaction accounts for authorization and settlement, the reserve transaction account follows a dual messaging protocol. This is in contrast to a debit transaction instrument that follows a single messaging protocol. Stated another way, in general, for a debit transaction account, the transaction is authorized and settled with a similar or the same message transmitted via the point of sale (POS) device. Thus, in general for debit cards, during a transaction, the message that comes from the POS device through a financial network to the issuer is used both to authorize the transaction and also to settle it (authorize the transfer of funds from a user's account to another's account). In this case, funds are almost immediately debited from the user's associated demand deposit account 150 associated with the debit transaction account.

With regard to a transaction with a credit, charge and/or reserve transaction account, initially an authorization request is transmitted via a payment network to an authorizer. If the transaction is approved, at some point in the near future, a settlement record is created and sent through the network from the merchant to the issuer (who may be the authorizer) for processing and/or settlement.

In general, credit and charge transaction accounts do not have a bank account tied to the various accounts for settlement. Instead, a user may pay these accounts from whichever source of funds they desire. This is in contrast to a reserve transaction account where a shadow reserve account 160 is created and associated with the reserve transaction account. In general, a demand deposit account 150 (such as a savings and/or checking account) is also associated with the reserve transaction account. A customer holding demand deposit account 150 may be criteria for enrolling in/being issued a reserve transaction account. According to the account holders' desires, in various embodiments, automatic payment of all or a portion of the transactions incurred may be funded from any demand deposit account such as shadow reserve account 160. This payment or multiple partial payments may occur at any time.

As described further below, this shadow reserve account 160 effectively assists the account holder with the automatic transfer of funds from demand deposit account 150 to shadow reserve account 160 in response to the reserve transaction account being used in a transaction. In response to opting in by the account holder, according to various embodiments, this transfer of funds happens passively and automatically in response to a reserve transaction account transaction, without the account holder actively participating in the transfer of funds from demand deposit account 150 to shadow reserve account 160. The account holder has full access to both demand deposit account 150 and to shadow reserve account 160. According to various embodiments, the account holder may transfer funds between demand deposit account 150 and to and/or from shadow reserve account 160 (in either direction). According to various lending institution protocols, the transfer of funds between accounts by the account holder may subject the account holder to a transfer fee. According to various embodiments, the account holder may draw down demand deposit account 150 and/or add to shadow reserve account 160 as desired at any time. Similarly, according to various embodiments, the account holder may draw down shadow reserve account 160 and/or add to demand deposit account 150 as desired at any time. According to various embodiments, at the time the reserve transaction account line of credit is extended, there is no linked bank account (either demand deposit account 150 and/or shadow reserve account 160) which is the default mechanism for payment of the outstanding balance of the reserve transaction account. Also, the reserve transaction account creates at least some risk of default for the financial institution issuing the transaction account.

According to various embodiments, as a reserve transaction account holder uses the reserve transaction account in transactions the reserve transaction account has features that help the reserve transaction account holder manager their funds. For instance, as a reserve transaction account holder uses the reserve transaction account in transactions, the corresponding dollar amounts of the transactions are automatically transferred from the selected/associated demand deposit account 150 account to shadow reserve account 160. This may occur at any time, such as in concert with a transaction, or shortly after a transaction has occurred. Thus, the balance of the associated demand deposit account 150 is reduced automatically by the transaction amount and stored in shadow reserve account 160 and therefore helps the reserve transaction account holder budget for future expenditures. Thus, the reserve transaction account holder can manage their spend by inspecting their current demand deposit account 150 balance. If they do not spend over their demand deposit account 150 balance they are less likely to incur charges that they are not able to pay-off in full.

At some later point, the reserve transaction account holder can use any source of funds to pay the balance of their reserve transaction account, such as shadow reserve account 160 balance, demand deposit account 150 funds and/or other sources of funds. Importantly, though funds are transferred from demand deposit account 150 to shadow reserve account 160, substantially at the time of purchase or reconciliation, and/or settlement, these funds are not frozen from the shadow reserve account 160 holder's use. The reserve transaction account holder can access the funds from demand deposit account 150 and/or shadow reserve account 160 and make transfers, withdrawals, and/or potentially draft checks against the balance at substantially any time. This is in contrast to a debit transaction account, where funds would be frozen from an account holder's access as close to the time of purchase as possible. Thus, unlike debit transaction account products, the issuer of the reserve transaction account assumes a risk of default. For instance, a reserve transaction account holder could use the reserve transaction account in transactions which automatically transfers funds from demand deposit account 150 to shadow reserve account 160. At any time the reserve transaction account holder could withdraw some or all of remaining funds in demand deposit account 150 and/or shadow reserve account 160. Thus, the issuer of the reserve transaction account has no guarantee of repayment and the reserve transaction account holder is able to have zero dollars in both their demand deposit account 150 and shadow reserve account 160. Even with zero dollars in both demand deposit account 150 and/or shadow reserve account 160 transactions using the reserve transaction account may still be approved based upon a dynamic credit limit established and updated for each user. Of course, the reserve transaction account holder may pay their reserve transaction account balance from another transaction account and/or savings account if they desire.

According to various embodiments, at the time of issuing the reserve transaction account, there is no default payment system set up between the reserve transaction account and a bank account. Instead, a transaction account holder may opt in to having an associated demand deposit account selected for payment of some or all of the balance on the reserve transaction account (at any time). A financial institution, may offer an incentive to encourage the transaction account holder to opt in to having an associated demand deposit account used for payment of some or all of the balance on the reserve transaction account. This incentive may be a reward of loyalty points in a loyalty account, a reduction in fees, an increase in savings return, a gift, a deposit of additional funds, and/or the like.

Thus, according to various embodiments, a standard/existing charge or credit transaction account may be converted to a reserve transaction account. This may occur in response to enrolling in the reserve transaction account. This may occur in response an account holder being issued a demand deposit account 150 and/or associating demand deposit account 150 with the charge or credit transaction account product.

An existing charge or credit transaction account may be converted to a reserve transaction account. Also the reserve transaction account may be applied for and/or newly issued. Demand deposit account 150 may be existing, newly created and/or in the process of being created at the time of association with the reserve transaction account.

In general, after and/or in concert with demand deposit account 150 being linked to the reserve transaction account a shadow reserve account 160 is created. Generally, this shadow reserve account 160 is held at the same financial institution as the Account Holder's demand deposit account 150.

According to various embodiments, shadow reserve account 160 need not be held at the same financial institution as the financial institution holding the Account Holder's demand deposit account 150.

Referring now to FIGS. 1-5, the process flows and screenshots depicted are merely embodiments and are not intended to limit the scope of the disclosure as described herein. For example, the steps recited in any of the method or process descriptions may be executed in any order and are not limited to the order presented.

According to various embodiments and with reference to FIG. 1A, an exemplary reserve transaction account holder experience 110 is depicted. For instance, on May 1^{st} the Reserve account holder may have $1,000 in demand deposit account 150. On the 1^{st}, the reserve transaction account holder travels to the grocery store and uses their reserve transaction account to buy $125.00 worth of groceries. Shortly thereafter, in the reserve transaction account holder's demand deposit account 150, the available funds/balance decreases by $125.00 to $875.00. This mechanism is intended to reinforce the pay now mentality of consumers who want financial control over their accounts. However, this $125 isn't actually deducted from their accounts overall at the financial institution holding both demand deposit account 150 and shadow reserve account 160. The $125 is simply transferred over, via bookkeeping, to shadow reserve account 160. Thus, after the initial grocery purchase shadow reserve account 160 balance of $0 is increased to $125.

On May 7^{th}, the reserve transaction account holder makes an ATM withdrawal using the reserve transaction account against demand deposit account 150 which again decreases the available funds in their demand deposit account 150 but it does not sweep any money into shadow reserve account 160 because the cash has been withdrawn from demand deposit account 150 and converted to cash. Stated another way, the withdrawn cash is not a transaction that can be paid later so there is no need reinforce the pay now mentality.

Then, on May 25^{th}, the reserve transaction account holder goes out to dinner and spends $65 using the reserve transaction account. The reserve transaction account holder's balance in demand deposit account 150 decreases by $65 to $710. The reserve transaction account holder's balance in shadow reserve account 160 is increased by $65 as $65 is transferred into the reserve transaction account holder's shadow reserve account 160.

On May 30^{th}, the reserve transaction account holder has $710 in demand deposit account 150 and the reserve transaction account holder has $190 in shadow reserve account 160. Between the two accounts, e.g. demand deposit account 150 and shadow reserve account 160, there is a $1,000 balance minus the withdrawn $100 in cash that reserve transaction account holder had at the beginning of the month.

Generally, the financial institution, such as a bank, issuing the reserve transaction account would on a periodic basis, such as a monthly basis, issue the reserve transaction account holder a statement telling the reserve transaction account holder that the reserve transaction account balance is $190 and the reserve transaction account holder need to pay the bill within a period of time, such as within 20 days. This payment may be a full or partial payment made from any source or combination of sources of funds, such as shadow reserve account 160, demand deposit account 150, a different demand deposit account, another transaction instrument, and/or the like. Also, at any time the reserve transaction account holder may choose to have the reserve transaction account balance paid, such as automatically on a selected date, which may be any date, such as 1^{st} of the month, with a sweep of the money from shadow reserve account 160.

According to various embodiments and with reference to FIG. 1B, an exemplary reserve transaction account holder experience 115 is depicted. This reserve transaction account holder experience is similar to the reserve transaction account holder experience as depicted in FIG. 1A.

In the example of FIG. 1B, the reserve transaction account holder spends $225 at the grocery store on May 1^{st}. This initiates a transfer of $225 from demand deposit account 150 to shadow reserve account 160.

As depicted before in FIG. 1A, on May 7^{th}, the reserve transaction account holder makes an ATM withdrawal using the reserve transaction account against demand deposit account 150 which again decreases the available funds in their demand deposit account 150, such as a checking account, but it does not sweep any money into shadow reserve account 160 because the cash has been withdrawn from demand deposit account 150.

Next, the reserve transaction account holder makes a transfer electronically, such as from a web based portal or mobile application of $100 from shadow reserve account 160 to demand deposit account 150. This reduces the balance of shadow reserve account 160 from $225 to $125. This transfer also increases the available balance of demand deposit account 150 by $100 from $675 to $775.

On May 25^{th} the reserve transaction account holder goes out to dinner and spends $65. The reserve transaction account holder's balance in demand deposit account 150 decreases by $65 to $710. The reserve transaction account holder's balance in shadow reserve account 160 is increased by $65. Thus, $65 is transferred into the reserve transaction account holder's shadow reserve account 160 for a total of $190.

On May 27, the reserve transaction account holder makes an ATM withdrawal of $50 using the reserve transaction account against demand deposit account 150 which again decreases the available funds in their demand deposit account 150, such as a checking account, but it does not sweep any money into shadow reserve account 160 because the cash has been withdrawn from demand deposit account 150.

According to various embodiments, a single reserve transaction instrument may be linked to access funds in both demand deposit account 150 and shadow reserve account 160.

As depicted in FIG. 1B, on May 30th, the reserve transaction account holder has $660 in demand deposit account 150 and has $190 in shadow reserve account 160. Between the two accounts, e.g. demand deposit account 150 and shadow reserve account 160, there is a $1,000 balance minus the withdrawn $150 reflecting the $150 withdrawn from demand deposit account 150.

Similar to FIG. 1A, in FIG. 1B the financial institution, such as a bank, issuing the reserve transaction account would issue the reserve transaction account holder a statement telling the reserve transaction account holder that the reserve transaction account balance is $290 ($225+$65) and the reserve transaction account holder need to pay the bill within a preset period, such as within 20 days. This payment may be made from any source of funds. At any time the reserve transaction account holder may choose to have the reserve transaction account have funds allocated to its payment. This may be automatically on a selected date, which may be any date, such as 1^{st} of the month, with a sweep of the money from shadow reserve account 160 and another account if needed, such as through a combination of demand deposit account 150 and shadow reserve account 160 and/or an overdraft protection mechanism.

A reserve transaction account holder may receive an incentive such as loyalty points for balances in their accounts, such as demand deposit account 150 and shadow reserve account 160, use of their reserve transaction account, setting up auto-payment of their reserve transaction account from their shadow reserve account 160, having available funds in their shadow reserve account 160 to cover a periodic balance, such as monthly balance of their reserve transaction account and/or the like. A reserve transaction account holder may receive interest on both or either of their demand deposit account 150 and shadow reserve account 160.

Due to the risks experienced by the creditor of the reserve transaction account, a credit limit and/or credit line may be set on each reserve transaction account. This limit may be based on a credit score, income, payment history, FICO scores, liabilities, lawsuits, available funds, balance of demand deposit account 150 and/or shadow reserve account 160. According to various embodiments, this credit limit may be dynamic based on the balance of demand deposit account 150 and/or shadow reserve account 160. This dynamic credit limit may be available in real time via a software application to a reserve transaction account holder. For some that are higher risk, the dynamic credit limit may be an amount set close to the balance of demand deposit account 150. For instance, as funds are increased in demand deposit account 150 the limit of reserve transaction account may be increased as appropriate. An accounting of the sum of demand deposit account 150 and shadow reserve account 160 may affect the raising of limit of reserve transaction account.

According to various embodiments, various permissions may be set on access to shadow reserve account 160. For instance, a first reserve transaction account holder such as a parent and/or employer may be issued a reserve transaction account for joint use with a second user such as a dependent and/or employee, respectively. The parent may have freedom to transfer funds freely between demand deposit account 150 and/or shadow reserve account 160, whereas the second user may not have permission to transfer funds between demand deposit account 150 and/or shadow reserve account 160. The first reserve transaction account holder may set a limit on use of the reserve transaction account, similar to the credit limit established by the issuer, at a desired level. This established limit may be the available balance of demand deposit account 150 or another preselected limit. If the permission is set that the second user may not access funds in shadow reserve account 160 and the spend using the reserve transaction account cannot exceed the balance of the demand deposit account 150, when the reserve transaction account payment is due, so long as the first user has not decreased the amount of funds in shadow reserve account 160, shadow reserve account 160 will likely have enough funding to cover the reserve transaction account balance. This may assist with enduring financial obligations may be met.

Turning to FIG. 2, a flowchart depicting an exemplary transaction process and settlement flow 200 including decisioning that occurs with each transaction is depicted. In an exemplary embodiment a financial institution, such as a bank, issuing the reserve transaction account is responsible for making credit decisions such as the actual approval decision for each transaction. A third party risk analysis is provided to the financial institution with a recommendation, based on risk modeling for each reserve transaction account holder. The financial institution does not have to follow that third party provided recommendation.

With continued reference to FIG. 2, a reserve transaction account holder initiates a transaction with a merchant. In response to the initiation, generally via a POS device, an authorization request is received by the third party risk analysis provider. Certain risk models will also utilize data that is provided by the issuer (such as provided via a daily feed). Thus, in this depiction, the issuer has certain data, such as credit data, that the third party risk analysis provider doesn't have access to pertaining to that reserve transaction account holder. This credit data may be provided to the third party risk analysis provider. Thus, the third party risk analysis provider will pull for each individual reserve transaction account holder the issuer credit data on a periodic basis, such as daily. This latest key credit information that third party risk analysis provider then stores (pushes) to a database to be used by the third party risk analysis provider risk models and/or the third party risk analysis provider credit authorization system. For instance, the third party risk analysis provider is provided with data from the financial institution issuing the reserve transaction account. This data is stored by the third party risk analysis provider. As a new transaction comes in for each individual account, the third party risk analysis provider applies the stored data to the models for that individual reserve transaction account holder. Thus, dynamic modifications to the models may be made based on this updated data.

Thus, in various embodiments, the third party risk analysis provider may not have access any identifying information other than the reserve transaction account code/number. Thus, the third party risk analysis provider may not know the reserve transaction account holder's name, etc.

An authorization request is sent to the third party risk analysis provider's system from a POS device, such as a Merchant POS device or a user's computing device. The third party risk analysis provider uses the risk models it has, included the stored data from the financial institution issuer on that individual reserve transaction account holder. The risk models may take into account the velocity of transactions, amount of transactions, balances on transaction accounts, payment history, transaction history, geographic location of transactions, ship to addresses listed, fraud alerts, legal actions, bankruptcies, transactions outside of historical norms, current account balances, and/or the like may be reviewed prior to authorizing each transaction. The third party risk analysis provider makes a decision based on the models and transmits to the financial institution issuer a recommendation.

Stated another way the third party risk analysis provider sends the “auth” request to the financial institution issuer. This “auth” request may comply with standard “auth” request ISO formatting of POS messaging. This “auth” request includes a value in an embedded field which is a recommendation to either approve or decline a transaction. According to various embodiments, in addition to the recommendation, additional reference information may be included in the “auth” request message (also complying with ISO formatting). For instance, in other fields of the ISO formatted message, which models were used and/or a reason code may be included. For instance, if the third party risk analysis provider feels that there is a high probability of fraud, the third party risk analysis provider can indicate that reason code to the financial institution issuer in the transmitted message. These “auth” request messages may be communicated via point of sale devices.

The financial institution issuer receives the “auth” request including the recommendation. The financial institution issuer reads the recommendation, and other substantially real-time information to determine if they wish to authorize or decline the transaction. They may ignore the recommendation if desired. For instance, if demand deposit account 150 had recently been infused with a significant amount of funds, if sufficient overdraft is in place, and/or the like. Thus, the financial institution may scale the weight of the recommendation message and weight that scaled value against the weight attributed to internal data.

A decision to authorize or decline the transaction is made and communicated in a response. This response is transmitted back to the third party risk analysis provider and then sent from the third party risk analysis provider to the Merchant POS device or a user's computing device. Alternatively, this response may be sent back directly to the Merchant POS device or a user's computing device directly (not depicted).

If the transaction is approved, then at some point in the near future, such as within hours and/or overnight, a settlement record is created and sent via the payment/financial network from the merchant to the financial institution issuer for settlement. Funds may be transferred from demand deposit account 150 to shadow reserve account 160 to reflect each transaction (and/or an aggregate amount of transactions) at this time. In the alternative, funds may be reflected as “pending transfer” on an electronic ledger viewable by a reserve transaction account holder in response to the response indicating approval from the financial institution issuer for each transaction. In this case, the actual transfer may occur in response to settlement.

According to various embodiments, a credit line of a reserve transaction account holder may be equal to half of the reserve transaction account average balance, which may be dynamic as this balance may be calculated in response to each transaction taking into account in substantially real-time each debit and credit against the reserve transaction account and other real-time account data.

According to various embodiments and with reference to FIG. 3, in response to the third party risk analysis provider receiving the auth request from the merchant, a decision is made to process the transaction or not. If the decision is to authorize the transaction, this response is communicated directly back to the merchant. At some point in the near future and/or concurrently with the transmission being sent to the merchant to authorize the transaction, a post-authorization record is transmitted to the issuer. In this way a reserve transaction account holder may inquire with either the issuer or the third party risk analysis provider why the transaction was declined.

According to various embodiments and with reference to FIG. 4, a flowchart depicting an exemplary transaction process and settlement flow 400 including decisioning that occurs with each transaction is depicted. According to various embodiments a financial institution, such as a bank, issuing the reserve transaction account is responsible for making credit decisions such as the actual approval decision for each transaction. In this scenario the risk analysis provided by the third party in the embodiment depicted in FIG. 2, is performed by the financial institution, such as performed in-house.

With continued reference to FIG. 4, a reserve transaction account holder initiates a transaction with a merchant. In response to the initiation, generally via a POS device, an authorization request is received by the financial institution. The financial institution has real time access to each individual reserve transaction account holder. This information is used in risk models. This information may be updated dynamically to be current as of each transaction. The risk models may take into account the velocity of transactions, amount of transactions, balances on transaction accounts, payment history, transaction history, geographic location of transactions, ship to addresses listed, fraud alerts, legal actions, bankruptcies, transactions outside of historical norms, current account balances, and/or the like may be reviewed prior to authorizing each transaction.

As a new transaction comes in for each individual account, the financial institution applies its stored data to the models for that individual reserve transaction account holder. Thus, dynamic modifications to the models may be made based on this updated data with each transaction requested and/or performed. An authorization request is sent to the financial institution from a POS device, such as a Merchant POS device or a user's computing device.

If the financial institution feels that there is a high probability of fraud based on the risk modeling the financial institution can decline the transaction and append a record of the declines transaction with a reason code for that message. This decline may be transmitted from the financial institution to the merchant via a POS device. If the financial institution feels is an acceptable probability of fraud based on the risk modeling the financial institution can authorize the transaction and append a record of the approved transaction with a reason code for that message. This authorization may be transmitted from the financial institution to the merchant via a POS device.

According to various embodiments, and with reference to FIG. 5, the present system 500 further comprises an enrolling system 102, an authentication system 104, an issuing system 106, database 109, a tracking system 120 and a payment processing system 112, all or some of which can be coupled via a network 108. Customers wanting to establish a reserve transaction account with a financial institution, such as a bank, issuing the reserve transaction account may enter information or data into enrolling system 102. This information can be, for example, personal, financial, biographical, biometrical, or other relevant information. The information is transmitted via network 108 (or directly in some examples) to authentication system 104. Authentication system 104 can be operated and positioned as an issuing financial institution's system or can be a third party system, in various examples. The authentication system 104 may perform a fraud check, an identity verification, an identity validation, and/or a credit worthiness check. In addition, authentication system 104 may obtain information from third party sources (including, but not limited to, credit bureaus) regarding the applicant for consideration. The authentication system 104 may determine if the customer has an existing demand deposit account, an existing charge and/or credit transaction account held at the financial institution. In one exemplary embodiment, in response to the results of the authentication system 104 authentication process (e.g., based on preset threshold of risk and preprogrammed logic) a customer may be offered (e.g., by issuing system 106) a reserve transaction account, customer may be offered (e.g., by issuing system 106) to transition an existing charge and/or credit transaction account to a reserve transaction account, a customer may be offered (e.g., by issuing system 106) a demand deposit account 150, a customer may be offered (e.g., by issuing system 106) a shadow reserve account 160, a customer may be prompted to verify and/or re-enter customer information, a customer may be prompted to verify and/or re-enter customer information, such as demand deposit account (DDA) information, and/or a customer may be rejected (e.g., by issuing system 106). A customer may accept an offer or the customer may reject an offer. According to various embodiments, a customer may be required to hold a demand deposit account to hold a reserve transaction account. Stated another way, a restriction may be placed on the reserve transaction account that a demand deposit account must be held by the customer for activation and/or continued use of the reserve transaction account.

Generally, if approved, a user having a demand deposit account (generally at that financial institution) is issued a reserve transaction account by the financial institution. At this time, the financial institution also creates shadow reserve account 160 and links it to the customer's demand deposit account 150.

If the financial institution is not the issuer of the demand deposit account provided by the customer during enrollment the customer may provide consent and an appropriate user name/password for allowing the reserve transaction account issuer to sign into online banking services of the Demand deposit account holding bank for the purposes of obtaining available balance information and transferring balances between the demand deposit account and the established shadow reserve account 160 at the financial institution.

In one exemplary embodiment, an account automatic payment program may be associated with the reserve transaction account by the customer. The automatic payment program may be configured to pay all or a selectable portion of purchases completed using the reserve transaction account. The automatic payment program may be associated with demand deposit account 150 and/or shadow reserve account 160. The pre-selected amount automatically paid by the automatic payment program may be the minimum balance requested by the transaction account issuer. The pre-selected amount may be the balance payment in full. The pre-selected amount may be any suitable amount, but is generally greater than the minimum balance requested by the account issuer.

In one exemplary embodiment, in response to payments of a pre-selected amount being received on or before the due date the consumer may be rewarded with an incentive, such as reward points being granted in a loyalty program. In one exemplary embodiment, in response to payments of a pre-selected amount being received on or before the due date paid from shadow reserve account 160 the consumer may be rewarded an incentive, such as being granted reward points in a loyalty program. In one exemplary embodiment, the incentive includes increasing the dynamically adjusted credit limit threshold on the reserve transaction account for each transaction.

In one example, customers of the offered transaction account may accrue points towards a loyalty program for any of the steps or actions set forth herein, such as the American Express Membership Rewards, Delta SkyMiles, Hilton HHonors, Starwood Points, Discover Cashback Bonus, or the like. Points accrued via this product may be aggregated to an existing loyalty program account. In lieu of points, the issuer may offer cash back on purchases or any other incentive.

In an exemplary embodiment, the system may include an interface on a display for communicating with a user, such as a customer, enrolling in a reserve transaction account. This display may be embodiment in a computer system and/or on a mobile device. In this embodiment, a user may be asked to accept the terms and conditions associated with the reserve transaction account and provide additional information.

A display may depict an “autopay” enrollment (i.e. with an automatic payment) associated with previously issued a reserve transaction account. This may occur after the user has used the reserve transaction account in transactions with merchants and/or after issuance of the reserve transaction account. In this embodiment, a user may select an automatic payment account type (e.g. from a drop down menu) submit and/or verify account and routing information with verification controls, such as entering both the account and routing information more than once of financial account. In this embodiment, a user may be asked to accept the terms and conditions associated with an automatic payment function associated with the reserve transaction account. In this embodiment, a user may confirm the accuracy of submitted information. In another exemplary embodiment, a display may depict an approval of a reserve transaction account or a denial of a reserve transaction account.

A display may depict a substantially real-time dynamically changing credit limit, balance information, reward point balance and/or the like. This dynamically changing credit limit may be updated based on transaction approvals issued by financial institutions or settlement information received from merchants. Thus, at times the presented information may be temporary until confirmed through a settlement process, such as the settlement process depicted in FIG. 6.

According to various embodiments, additional shadow reserve accounts may be automatically created for the user based on the attributes of the purchase. According to various embodiments, based on the attributes of a purchase a value of funds may be transmitted to a specific shadow reserve accounts. For instance, payments of utilities may be allocated to a utility shadow reserve account whereas flight spending using reserve transaction account may be transferred from demand deposit account 150 to a travel shadow reserve account. Also, the amount of the transaction may trigger allocation. For instance, purchases under a pre-set threshold such as $100 may be automatically transferred according to the embodiments described herein from demand deposit account 150 to shadow reserve account 160, whereas transactions above the preset threshold are transferred from demand deposit account 150 to large purchase shadow reserve account. Though $100 is discussed, this threshold may be set at any value.

According to various embodiments and with reference to FIG. 6, a flowchart depicting an exemplary transaction process 600 is presented. For instance, a Merchant may transmit a report on compliance (ROC) to the third party system (or directly to the issuing financial institution) to assist with clearing and settlement. This information may be stored by the third party system and is then transmitted to the issuing financial institution. This information may be sent at any time according to any schedule. For instance, this information may be sent overnight daily. The issuing financial institution may use this information to initiate the transfer of funds from demand deposit account 150 to shadow reserve account 160. This information is also used in preparing a statement to present to a reserve transaction account holder.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account.

For example, the cardmember may include a transaction account owner, an transaction account user, an account affiliate, a child account user, a subsidiary account user, a beneficiary of an account, a custodian of an account, and/or any other person or entity affiliated or associated with a transaction account.

As used herein, “match” or similar terms may include an identical match, a partial match, matching a subset of data, a correspondence, an association, an algorithmic relationship and/or the like. Similarly, as used herein, “authenticate” or similar terms may include an exact authentication, a partial authentication, authenticating a subset of data, a correspondence, an association, an algorithmic relationship and/or the like. As used herein, “matches” or similar terms may include an exact match, partial match, suitably associated with, meeting certain criteria, satisfying certain rules and/or the like.

Any communication, transmission and/or channel discussed herein may include any system or method for delivering content (e.g. data, information, metadata, etc), and/or the content itself. The content may be presented in any form or medium, and in various embodiments, the content may be delivered electronically and/or capable of being presented electronically. For example, a channel may comprise a website or device (e.g., Facebook, YOUTube, AppleTV, Pandora, xBox, Sony Playstation), a uniform resource locator (“URL”), a document (e.g., a Microsoft Word document, a Microsoft Excel document, an Adobe .pdf document, etc.), an “ebook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel and/or the communication channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, Foursquare®, Twitter®, MySpace®, LinkedIn®, and the like. Examples of affiliate or partner websites include American Express®, Groupon®, LivingSocial®, and the like. Moreover, examples of mobile device communications include texting, email, and mobile applications for smartphones.

A “consumer profile” or “consumer profile data” may comprise any information or data about a consumer that describes an attribute associated with the consumer (e.g., a preference, an interest, demographic information, personally identifying information, and the like).

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

The computer systems disclosed herein also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signal capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include web servers (e.g. APACHE, IIS, GWS, SUN JAVA SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Phrases and terms similar to an “item” may include any good, service, information, experience, data, content, access, rental, lease, contribution, account, credit, charge, benefit, right, reward, points, coupons, credits, monetary equivalent, anything of value, something of minimal or no value, monetary value, non-monetary value and/or the like. Moreover, the “transactions” or “purchases” discussed herein may be associated with an item. Furthermore, a “reward” may be an item.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSI, or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “end user”, “account holder,” “consumer”, “customer”, “cardmember”, “business” or “merchant” may be used interchangeably with each other, and each shall mean any person, entity, government organization, business, machine, hardware, and/or software. A bank may be part of the system, but the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

Each participant is equipped with a computing device in order to interact with the system and facilitate online commerce transactions. The customer has a computing unit in the form of a personal computer, although other types of computing units may be used including laptops, notebooks, hand held computers, set-top boxes, cellular telephones, touch-tone telephones and the like. The merchant has a computing unit implemented in the form of a computer-server, although other implementations are contemplated by the system. The bank has a computing center shown as a main frame computer. However, the bank computing center may be implemented in other forms, such as a mini-computer, a PC server, a network of computers located in the same of different geographic locations, or the like. Moreover, the system contemplates the use, sale or distribution of any goods, services or information over any network having similar functionality described herein

The merchant computer and the bank computer may be interconnected via a second network, referred to as a payment network. The payment network which may be part of certain transactions represents existing proprietary networks that presently accommodate transactions for credit cards, charge cards, and other types of financial/banking cards. The payment network is a closed network that is assumed to be secure from eavesdroppers. Exemplary transaction networks may include the American Express®, VisaNet® and the Veriphone® networks.

The electronic commerce system may be implemented at the customer and issuing bank. In an exemplary implementation, the electronic commerce system is implemented as computer software modules loaded onto the customer computer and the banking computing center. The merchant computer does not require any additional software to participate in the online commerce transactions supported by the online commerce system.

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. §101.

In yet another embodiment, the transponder, transponder-reader, and/or transponder-reader system are configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

Phrases and terms similar to an “entity” may include any individual, consumer, customer, group, business, organization, government entity, transaction account issuer or processor (e.g., credit, charge, etc.), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, embossed card, smart card, magnetic stripe card, bar code card, transponder, radio frequency card or an associated account.

The system may include or interface with any of the foregoing accounts, devices, and/or a transponder and reader (e.g. RFID reader) in RF communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFID reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2 available at http://www.emvco.com/default.aspx.

The account number may be distributed and stored in any form of plastic, electronic, magnetic, radio frequency, wireless, audio and/or optical device capable of transmitting or downloading data from itself to a second device. A consumer account number may be, for example, a sixteen-digit account number, although each credit provider has its own numbering system, such as the fifteen-digit numbering system used by American Express. Each company's account numbers comply with that company's standardized format such that the company using a fifteen-digit format will generally use three-spaced sets of numbers, as represented by the number “0000 000000 00000”. The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer. A merchant account number may be, for example, any number or alpha-numeric characters that identify a particular merchant for purposes of account acceptance, account reconciliation, reporting, or the like.

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “transaction account” may include any account that may be used to facilitate a financial transaction.

Phrases and terms similar to “financial institution” or “transaction account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

The terms “payment vehicle,” “financial transaction instrument,” “transaction instrument” and/or the plural form of these terms may be used interchangeably throughout to refer to a financial instrument.

Phrases and terms similar to “merchant,” “supplier” or “seller” may include any entity that receives payment or other consideration. For example, a supplier may request payment for goods sold to a buyer who holds an account with a transaction account issuer.

Phrases and terms similar to a “buyer” may include any entity that receives goods or services in exchange for consideration (e.g. financial payment). For example, a buyer may purchase, lease, rent, barter or otherwise obtain goods from a supplier and pay the supplier using a transaction account.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location. Transaction vendor/merchant location may contain a high degree of specificity to a vendor/merchant. For example, transaction vendor/merchant location may include a particular gasoline filing station in a particular postal code located at a particular cross section or address. Also, for example, transaction vendor/merchant location may include a particular web address, such as a Uniform Resource Locator (“URL”), an email address and/or an Internet Protocol (“IP”) address for a vendor/merchant. Transaction vendor/merchant, and transaction vendor/merchant location may be associated with a particular consumer and further associated with sets of consumers. Consumer payment data includes any data pertaining to a consumer's history of paying debt obligations. Consumer payment data may include consumer payment dates, payment amounts, balance amount, and credit limit. Internal data may further comprise records of consumer service calls, complaints, requests for credit line increases, questions, and comments. A record of a consumer service call includes, for example, date of call, reason for call, and any transcript or summary of the actual call.

Phrases similar to a “payment processor” may include a company (e.g., a third party) appointed (e.g., by a merchant) to handle transactions. A payment processor may include an issuer, acquirer, authorizer and/or any other system or entity involved in the transaction process. Payment processors may be broken down into two types: front-end and back-end. Front-end payment processors have connections to various transaction accounts and supply authorization and settlement services to the merchant banks' merchants. Back-end payment processors accept settlements from front-end payment processors and, via The Federal Reserve Bank, move money from an issuing bank to the merchant bank. In an operation that will usually take a few seconds, the payment processor will both check the details received by forwarding the details to the respective account's issuing bank or card association for verification, and may carry out a series of anti-fraud measures against the transaction. Additional parameters, including the account's country of issue and its previous payment history, may be used to gauge the probability of the transaction being approved. In response to the payment processor receiving confirmation that the transaction account details have been verified, the information may be relayed back to the merchant, who will then complete the payment transaction. In response to the verification being denied, the payment processor relays the information to the merchant, who may then decline the transaction. Phrases similar to a “payment gateway” or “gateway” may include an application service provider service that authorizes payments for e-businesses, online retailers, and/or traditional brick and mortar merchants. The gateway may be the equivalent of a physical point of sale terminal located in most retail outlets. A payment gateway may protect transaction account details by encrypting sensitive information, such as transaction account numbers, to ensure that information passes securely between the customer and the merchant and also between merchant and payment processor.

Phrases similar to “vendor software” or “vendor” may include software, hardware and/or a solution provided from an external vendor (e.g., not part of the merchant) to provide value in the payment process (e.g., risk assessment).

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method comprising:
receiving, by a computer based system for assisting with meeting financial obligations, an authorization request for a transaction from a merchant involving a transaction account;
determining, by the computer based system, that the transaction should be authorized based on a comparison of transaction details to an individualized risk model associated with a transaction account holder,
transmitting, by the computer based system, the decision to process the transaction to the merchant; and
transferring, by the computer based system, a value of funds associated with the value of funds for the transaction from a demand deposit account associated with the transaction account to a shadow demand deposit account, wherein both the demand deposit account and the shadow demand deposit account are held by the transaction account holder.

2. The method of claim 1, further comprising updating the fraud risk model based on the decision to process the transaction.

3. The method of claim 1, wherein the transmitted authorization decision is appended to an international organization for standardization (ISO) formatted point of sale device protocol message.

4. The method of claim 1, wherein details indicating a reason for the transmitted authorization decision are appended to an ISO formatted point of sale device protocol message.

5. The method of claim 1, wherein the transaction account holder elects automatic payment of the transaction account from the shadow demand deposit account.

6. The method of claim 1, wherein issuer undertakes risk of default on payment of a balance of the transaction account.

7. The method of claim 1, wherein the transaction account comprises a dual messaging protocol for authorization and settlement.

8. The method of claim 1, wherein the transaction account is tied to a line of credit.

9. The method of claim 8, further comprising dynamically, substantially in concert with the decision to process the transaction, adjusting the line of credit based on each decision to process the transaction.

10. The method of claim 9, transmitting, by the computer based system, the dynamically adjusted line of credit and a calculated remaining credit limit to the transaction account holder in substantially real-time.

11. The method of claim 1, awarding an incentive to the transaction account holder for electing automatic payment of the transaction account from the shadow demand deposit account.

12. The method of claim 1, establishing the shadow demand deposit account in response to the transaction account holder being approved for the transaction account.

13. The method of claim 1, further comprising converting at least one of an existing charge or credit transaction account to the transaction account.

14. The method of claim 1, based on the attributes of the purchase funds are allocated to a second shadow demand deposit account.

15. The method of claim 1, wherein the transaction account is not a debit account.

16. The method of claim 1, wherein the demand deposit account is at least one of a savings account, a checking account, an asset managed investment, and a retirement account.

17. The method of claim 1, wherein demand deposit account ownership is a criteria for being issued the transaction account.

18. The method of claim 1, wherein the credit limit is tied to the balance of the sum of the balance of the demand deposit account and balance of the shadow demand deposit account.

19. A computer based system, comprising:
a computer network communicating with a memory;
the memory communicating with a processor for assisting with meeting financial obligations; and
the processor, when executing a computer program, performs operations comprising:
receiving, by the processor, an authorization request for a transaction from a merchant involving a transaction account;
determining, by the processor, that the transaction should be authorized based on a comparison of transaction details to an individualized risk model associated with a transaction account holder;
transmitting, by the processor, the decision to process the transaction to the merchant; and
transferring, by the processor, a value of funds associated with the value of funds for the transaction from a demand deposit account associated with the transaction account to a shadow demand deposit account, wherein both the demand deposit account and the shadow demand deposit account are held by the transaction account holder.

20. A non-transitory computer readable medium having stored thereon sequences of instruction, the sequences of instruction which, when executed by a computer based system for assisting with meeting financial obligations, causes the computer based system to perform the operations, comprising:
receiving, by the computer based system, an authorization request for a transaction from a merchant involving a transaction account;
determining, by the computer based system, that the transaction should be authorized based on a comparison of transaction details to an individualized risk model associated with a transaction account holder;
transmitting, by the computer based system, the decision to process the transaction to the merchant; and
transferring, by the computer based system, a value of funds associated with the value of funds for the transaction from a demand deposit account associated with the transaction account to a shadow demand deposit account, wherein both the demand deposit account and the shadow demand deposit account are held by the transaction account holder.
